(19) United States
(12) Patent Application Publication
(10) Pub. No.: US 2026/0077742 A1
(43) Pub. Date: Mar. 19, 2026

(54) VEHICLE CONTROL DEVICE AND VEHICLE

(71) Applicant: HONDA MOTOR CO., LTD., Tokyo (JP)

(72) Inventors: Ayumu MITOMO, Tokyo (JP); Jumpei NOGUCHI, Tokyo (JP); Gaku SHIMAMOTO, Tokyo (JP); Yusuke URANO, Tokyo (JP); Takashi KONDO, Tokyo (JP)

(73) Assignee: HONDA MOTOR CO., LTD., Tokyo (JP)

(21) Appl. No.: 19/330,209

(22) Filed: Sep. 16, 2025

(30) Foreign Application Priority Data
Sep. 18, 2024 (JP) 2024-160889

(51) Int. Cl. B60S 1/08; G05D 1/225

(52) U.S. Cl. CPC B60S 1/0818; B60S 1/0807; G05D 1/225

(57) ABSTRACT

A vehicle control device controls a vehicle configured to perform parking and exiting by a remote operation. The vehicle includes a cleaning device configured to clean a predetermined portion of an exterior of the vehicle, and the vehicle control device enables an operation of the cleaning device during the parking performed by the remote operation and restricts the operation of the cleaning device during the exiting performed by the remote operation.

### CROSS-REFERENCE TO RELATED APPLICATIONS

This application is based on and claims priority under 35 USC 119 from Japanese Patent Application No. 2024-160889 filed on Sep. 18, 2024, the contents of which are incorporated herein by reference.

### TECHNICAL FIELD

The present disclosure relates to a vehicle control device and a vehicle.

### BACKGROUND

In recent years, improvement in traffic safety has been required in order to enable inclusion, safety, toughness, and sustainability of urban and human residents.

From a viewpoint of improving traffic safety, development of a driving assistance technique and an automated driving technique for a moving object (for example, a vehicle) has been advanced. For example, Japanese Patent Application Laid-Open Publication No. 2019-089403A below discloses a technique for automatically parking a vehicle in a parking space by moving the vehicle in response to an operation on a terminal device performed by a driver who gets off the vehicle.

Further, the vehicle may include a cleaning device that cleans a predetermined portion of an exterior. As an example, the vehicle generally includes a wiper that wipes a front windshield.

However, in the related art, control on the cleaning device during parking and exiting of the vehicle performed by a remote operation has not been sufficiently studied.

The present disclosure provides a vehicle control device and a vehicle capable of appropriately controlling a cleaning device during parking and exiting of the vehicle performed by a remote operation and preventing breaking down or damage of the cleaning device itself or an exterior of the vehicle.

### SUMMARY

A first aspect of the present disclosure relates to a vehicle control device that controls a vehicle configured to perform parking and exiting by a remote operation, in which the vehicle includes a cleaning device configured to clean a predetermined portion of an exterior of the vehicle, and
the vehicle control device enables an operation of the cleaning device during the parking performed by the remote operation and restricts the operation of the cleaning device during the exiting performed by the remote operation A second aspect of the present disclosure relates to a vehicle configured to perform parking and exiting by a remote operation, the vehicle including:
a cleaning device configured to clean a predetermined portion of an exterior of the vehicle; and
a vehicle control device configured to control the vehicle, wherein
the vehicle control device enables an operation of the cleaning device during the parking performed by the remote operation and restricts the operation of the cleaning device during the exiting performed by the remote operation.

According to the present disclosure, it is possible to provide a vehicle control device and a vehicle capable of appropriately controlling a cleaning device during the parking and the exiting of the vehicle performed by the remote operation and preventing breaking down or damage of the cleaning device itself or the exterior of the vehicle.

### BRIEF DESCRIPTION OF DRAWINGS

Exemplary embodiments of the present disclosure will be described in detail based on the following figures, wherein

FIG. 1 is a block diagram showing an example of a movement control system 1 of the present embodiment;

FIG. 2 is a diagram showing an example of remote parking;

FIG. 3 is a diagram showing an example of remote exiting;

FIG. 4 is a diagram showing an example of control on a wiper 80 during remote parking;

FIG. 5 is a diagram showing an example of control on the wiper 80 during remote exiting;

FIG. 6 is a diagram showing an example of a case where a driver who performs a remote operation is far from a vehicle 2 in a first modification;

FIG. 7 is a diagram showing an example of a case where the driver who performs the remote operation is close to the vehicle 2 in the first modification; and

FIG. 8 is a diagram showing an example of control on the wiper 80 in a second modification.

### DESCRIPTION OF EMBODIMENTS

Hereinafter, an embodiment of a vehicle control device and a vehicle of the present disclosure will be described with reference to the drawings. The drawings are viewed in directions of reference numerals. The following embodiment does not limit the present disclosure, and not all of elements described in the following embodiment are necessary to the present disclosure. Hereinafter, the same or similar elements are denoted by the same or similar reference signs, and the description thereof may be omitted or simplified. In the following description, unless otherwise specified, front, rear, left, right, upper and lower directions will be described according to directions as seen by an occupant of the vehicle of the present embodiment (vehicle 2 to be described later).

### 1. Movement Control System

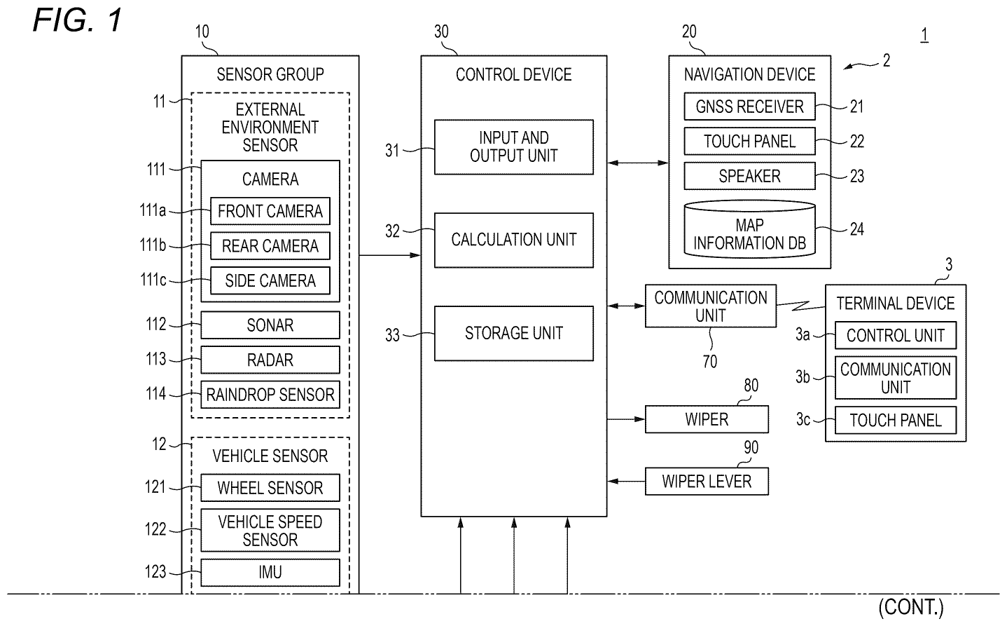

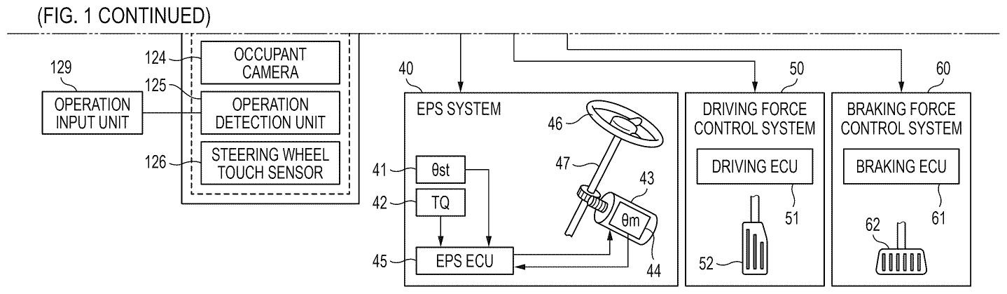

FIG. 1 is a block diagram showing an example of a movement control system 1 of the present embodiment. The movement control system 1 shown in FIG. 1 includes a vehicle 2 and a terminal device 3 that can communicate with each other. The movement control system 1 is a system capable of moving the vehicle 2 to a predetermined target parking position by automatic steering to park the vehicle 2 at the target parking position or moving the parked vehicle 2 from the parking position to a predetermined position by automatic steering to perform exiting, by a remote operation using the terminal device 3. Hereinafter, parking of the vehicle 2 performed by the remote operation using the terminal device 3 is also referred to as “remote parking”, and exiting of the vehicle 2 performed by the remote operation using the terminal device 3 is also referred to as “remote exiting”.

### Vehicle

The vehicle 2 is an example of the vehicle of the present disclosure, and is an automobile including a drive source (not shown), and wheels (not shown) including drive wheels driven by power of the drive source and steered wheels that are steerable. As an example, the vehicle 2 may be a four-wheeled automobile including a pair of left and right front wheels and a pair of left and right rear wheels.

The drive source of the vehicle 2 may be an electric motor, an internal combustion engine such as a gasoline engine or a diesel engine, or a combination of the electric motor and the internal combustion engine. The drive source of the vehicle 2 may drive the pair of left and right front wheels, the pair of left and right rear wheels, or the four wheels including the pair of left and right front wheels and the pair of left and right rear wheels. The front wheels or the rear wheels may be steerable steered wheels, or the front wheels and the rear wheels of the vehicle 2 may all be steerable steered wheels.

The vehicle 2 includes a sensor group 10, a navigation device 20, a control device 30, an electric power steering (EPS) system 40, a driving force control system 50, a braking force control system 60, a communication unit 70, and a wiper 80.

The sensor group 10 includes an external environment sensor 11 that acquires information on a periphery of the vehicle 2 (hereinafter also referred to as “peripheral information”), and vehicle sensors 12 that acquire information on the vehicle 2 (hereinafter also referred to as “vehicle information”). The information (in other words, detection values) acquired by each sensor in the sensor group 10 is output to the control device 30, and is used for control of the vehicle 2 (hereinafter, also referred to as “vehicle control”) performed by the control device 30.

The external environment sensor 11 includes, for example, cameras 111, a sonar 112, and a radar 113. The cameras 111 image the periphery of the vehicle 2 including a front side of the vehicle 2 and output image data of an obtained peripheral image to the control device 30. As the camera 111, for example, a digital camera using an imaging element such as a charge coupled device (CCD) or a complementary metal oxide semiconductor (CMOS) can be adopted.

More specifically, the cameras 111 include, for example, a front camera 111a, a rear camera 111b, and side cameras 111c. The front camera 111a is provided, for example, on a front grille (not shown) of the vehicle 2 and images a scene in front of the vehicle 2. The rear camera 111b is provided, for example, near a license plate (in other words, an automobile registration number mark) attached to a rear portion of the vehicle 2, and images a scene behind the vehicle 2. The side cameras 111c are provided, for example, on left and right side mirrors (not shown), and image scenes on lateral sides (that is, left and right sides) of the vehicle 2.

The sonar 112 emits sound waves to the periphery of the vehicle 2 (for example, the front side, a rear side, and the lateral sides of the vehicle 2), and receives reflected sounds from an object present in the periphery of the vehicle 2, thereby detecting a distance to the object from the vehicle 2, an azimuth of the object, and the like, and outputs a detection result to the control device 30. The radar 113 emits radio waves to the periphery of the vehicle 2 including the front side of the vehicle 2, and receives reflected waves from an object present in the periphery of the vehicle 2, thereby detecting a distance to the object, an azimuth of the object, and the like. As the radar 113, for example, a millimeter wave radar can be adopted.

The external environment sensor 11 may include light detection and ranging (LiDAR) instead of or in addition to the sonar 112 and the radar 113. In this case, the LiDAR emits laser light to the periphery of the vehicle 2 including the front side of the vehicle 2, and receives reflected light from an object present in the periphery of the vehicle 2, thereby detecting a distance to the object from the vehicle 2, an azimuth of the object, and the like.

A raindrop sensor 114 detects the presence or absence of raindrops in the periphery of the vehicle 2 and an amount of the raindrops (in other words, an amount of rainfall), and outputs a detection result to the control device 30. More specifically, the raindrop sensor 114 includes, for example, a light-emitting element such as an infrared light-emitting diode and a light-receiving element such as a photodiode, and is provided near the front windshield (not shown) of the vehicle 2. For example, when there is no raindrop on the front windshield, the light emitted from the light-emitting element of the raindrop sensor 114 is reflected by a surface of the front windshield and is incident on the light-receiving element. On the other hand, when there is a raindrop on the front windshield, the light emitted from the light-emitting element of the raindrop sensor 114 is transmitted through the raindrop, and thus an amount of light incident on the light-receiving element is smaller than that when there is no raindrop. By using such a principle, the raindrop sensor 114 can detect the presence or absence of raindrops and the amount of raindrops.

The vehicle sensor 12 includes, for example, a wheel sensor 121, a vehicle speed sensor 122, an inertial measurement unit (IMU) 123, an occupant camera 124, an operation detection unit 125, and a steering wheel touch sensor 126.

The wheel sensor 121 detects a rotation angle of one or more wheels among the wheels of the vehicle 2. As an example, the wheel sensor 121 detects rotation angles of the left rear wheel and the right rear wheel. As the wheel sensor 121, for example, an angle sensor or a displacement sensor can be adopted.

The vehicle speed sensor 122 detects a vehicle speed VP that is a travel speed of the vehicle 2 (in other words, a movement speed of a vehicle body). For example, the vehicle speed sensor 122 detects the vehicle speed VP based on a rotation speed of a counter shaft (not shown) provided in the vehicle 2.

The inertial measurement unit 123 detects angular velocities of the vehicle 2 in a pitch direction, a roll direction, and a yaw direction, and accelerations of the vehicle 2 in a front-rear direction, a left-right direction, and an upper-lower direction. The vehicle sensor 12 may include, instead of the inertial measurement unit 123, an acceleration sensor that detects an acceleration of the vehicle 2 in a predetermined direction or a gyro sensor that detects an angular velocity of the vehicle 2 in a predetermined direction.

The occupant camera 124 is a digital camera that images a vehicle interior of the vehicle 2 and outputs image data of an obtained vehicle interior image to the control device 30. For example, the occupant camera 124 can be a “driver monitor camera” that is provided to be able to image a head of an occupant (for example, a driver driving the vehicle 2) seated in a driver seat of the vehicle 2 from the front. Similar to the camera 111, a digital camera using an imaging element such as the CCD or the CMOS can be adopted as the occupant camera 124.

The operation detection unit 125 detects an operation performed using an operation input unit 129 provided to be operable by the occupant of the vehicle 2 (hereinafter, also simply referred to as “occupant”). The operation input unit 129 may include, for example, a start/stop switch (hereinafter also referred to as “SSSW”), an operation button for receiving an operation to execute the remote parking, and the like.

The steering wheel touch sensor 126 detects whether a steering wheel 46 of the vehicle 2 is gripped appropriately. For example, the steering wheel touch sensor 126 is implemented by a capacitance sensor or the like. In this case, the capacitance sensor is provided at a portion touched by the driver when the steering wheel 46 is gripped appropriately.

The navigation device 20 includes, for example, a global navigation satellite system (GNSS) receiver 21, a touch panel 22, and a speaker 23. The navigation device 20 includes a storage unit (not shown) implemented by a flash memory or the like. The storage unit of the navigation device 20 stores a map information database (DB) 24 and the like.

The map information database 24 includes road network information. The road network information is information representing each road based on a combination of nodes and links connecting the nodes (also referred to as “paths”). Each of the nodes in the road network information represents, for example, a feature of the corresponding road such as an intersection, a corner, or a dead end. In the road network information, for each of the nodes, for example, information indicating a location corresponding to the node (for example, coordinates that enable specifying of one point on a map such as a latitude and a longitude) is set. Further, in the road network information, for each of the links, information indicating the nodes at both ends of the corresponding link, a road corresponding to the link, a link length, the number of lanes, a traveling direction, a road type, and the like is set.

The GNSS receiver 21 specifies a current position of the vehicle 2 (for example, a latitude and a longitude of a location where the vehicle 2 is located) based on a signal received from a GNSS satellite. For example, the navigation device 20 may acquire a detection result of the vehicle sensor 12 (for example, the wheel sensor 121 or the vehicle speed sensor 122) via the control device 30, and specify or complement the current position of the vehicle 2 by an inertial navigation system (INS) using a detection value of the vehicle sensor 12.

The touch panel 22 is, for example, implemented by combining a display device such as a liquid crystal display or an organic light emitting diode (OLED) with a pointing device (for example, a touchpad). The speaker 23 is configured to output a sound to the occupant.

For example, the navigation device 20 searches for, by referring to the map information database 24, a route from the current position of the vehicle 2 to a destination set by the driver using the touch panel 22. Then, the navigation device 20 performs route guidance using the touch panel 22 and the speaker 23 based on the found route.

The navigation device 20 may cause the touch panel 22 to perform a predetermined display according to an instruction from the control device 30. Further, the navigation device 20 may output predetermined information (for example, information indicating an operation received via the touch panel 22) to the control device 30. As an example, the navigation device 20 may cause the touch panel 22 to perform a display for guiding the driver to a parking available position PS or a target parking position PT which are to be described later. The navigation device 20 may receive an operation of designating the target parking position PT by the driver through the touch panel 22 and output information indicating the designated target parking position PT to the control device 30.

The control device 30 is an example of the vehicle control device of the present disclosure and is a computer that integrally controls the entire vehicle 2. The control device 30 includes, for example, an input and output unit 31, a calculation unit 32, and a storage unit 33. The input and output unit 31 is an interface that inputs and outputs data between the inside and outside of the control device 30 under the control performed by the calculation unit 32. The storage unit 33 includes, for example, a nonvolatile storage medium such as a flash memory, and stores various types of information (for example, data and programs) necessary for the control device 30 to perform vehicle control.

The calculation unit 32 is, for example, implemented by a processor such as a central processing unit (CPU), that performs various calculations, and controls the entire vehicle 2 by executing the programs stored in the storage unit 33. Since specific examples of the vehicle control performed by the control device 30 will be described later, the description thereof will be omitted here. For example, the control device 30 is implemented by one electronic control unit (ECU) or by two or more ECUs working in cooperation with each other.

The EPS system 40 includes, for example, a steering angle sensor 41, a torque sensor 42, an EPS motor 43, a resolver 44, and an EPS ECU 45.

The steering angle sensor 41 detects a steering angle θst of the steering wheel 46 and outputs information indicating the detected steering angle θst to the EPS ECU 45. The torque sensor 42 detects a steering torque TQ, which is a torque applied to the steering wheel 46 of the vehicle 2, and outputs information indicating the detected steering torque TQ to the EPS ECU 45.

The EPS motor 43 assists the driver in operating the steering wheel 46 by applying, according to an instruction from the EPS ECU 45, a driving force or a reaction force to a steering column 47 connected to the steering wheel 46. The resolver 44 detects a rotation angle θm of the EPS motor 43 and outputs information indicating the detected rotation angle θm to the EPS ECU 45.

The EPS ECU 45 is, for example, a computer that includes a processor that performs various calculations, a storage unit including a non-transitory storage medium that stores various types of information, and an input and output unit that controls input and output of data between the inside and the outside of the EPS ECU 45 (none is shown), and controls the EPS system 40 (for example, the EPS motor 43). The EPS ECU 45 is implemented by one or two or more ECUs. For example, the EPS ECU 45 controls the EPS system 40 (for example, the EPS motor 43) based on the steering angle θst detected by the steering angle sensor 41, the steering torque TQ detected by the torque sensor 42, the rotation angle θm detected by the resolver 44, and the like. The EPS ECU 45 can also control the EPS system 40 according to an instruction from the control device 30.

Further, the EPS system 40 (for example, the EPS ECU 45) may output, to the control device 30, information indicating the steering angle θst detected by the steering angle sensor 41, the steering torque TQ detected by the torque sensor 42, the rotation angle θm detected by the resolver 44, and the like. Further, the EPS system 40 (for example, the EPS ECU 45) may output information indicating a steering speed ω of the steering wheel 46 to the control device 30. In this case, the steering speed ω is obtained by, for example, differentiating the steering angle θst with respect to time.

The driving force control system 50 includes a driving ECU 51, and is configured to control a driving force of the vehicle 2. The driving ECU 51 is, for example, a computer that includes a processor that performs various calculations, a storage unit including a non-transitory storage medium that stores various types of information, and an input and output unit that controls input and output of data between the inside and the outside of the driving ECU 51 (none is shown), and controls the driving force control system 50. The driving ECU 51 is implemented by one or more ECUs. For example, the driving ECU 51 controls power output from the drive source of the vehicle 2 based on an operation on an accelerator pedal 52 provided in the vehicle 2. The driving ECU 51 can also control the driving force control system 50 (for example, the drive source) according to an instruction from the control device 30.

The braking force control system 60 includes a braking ECU 61, and is configured to control a braking force of the vehicle 2. The braking ECU 61 is, for example, a computer that includes a processor that performs various calculations, a storage unit including a non-transitory storage medium that stores various types of information, and an input and output unit that controls input and output of data between the inside and the outside of the braking ECU 61 (none is shown), and controls the braking force control system 60. The braking ECU 61 is implemented by one or more ECUs. For example, the braking ECU 61 controls the braking force of the vehicle 2 by controlling a brake device (not shown) provided in the vehicle 2 based on an operation on a brake pedal 62 provided in the vehicle 2. Here, the brake device includes, for example, brake calipers, a cylinder that transmits a hydraulic pressure to the brake calipers, and an electric motor that generates a hydraulic pressure in the cylinder. The braking ECU 61 controls the electric motor of the brake device such that a braking force corresponding to the operation on the brake pedal 62 is generated. The braking ECU 61 can also control the braking force control system 60 (for example, the brake device) according to an instruction from the control device 30.

The communication unit 70 is a communication interface that performs wireless communication with a terminal device 3 under the control of the control device 30. That is, the vehicle 2 (for example, the control device 30) may communicate with the terminal device 3 via the communication unit 70. For example, a mobile communication network such as a cellular line, WI-FI (registered trademark), or Bluetooth (registered trademark) can be used for the communication between the vehicle 2 and the terminal device 3. The communication unit 70 may be configured to communicate with an external device (for example, a server device managed by a manufacturer of the vehicle 2) other than the terminal device 3.

The wiper 80 is an example of a cleaning device in the present disclosure, and is, for example, a cleaning device that cleans a front windshield (not shown) of the vehicle 2.

More specifically, for example, the wiper 80 wipes water droplets, dirt, or the like adhering to a to-be-wiped surface of the front windshield by moving in close contact with the front windshield.

The wiper lever 90 is an operator that receives an operation related to the wiper 80 and is provided on the steering column 47 such that the driver can operate with one hand, for example. In the present embodiment, the wiper lever 90 is configured to take four lever positions such as “OFF”, “AUTO”, “LO”, and “HI”, and outputs information indicating a current lever position to the control device 30. The driver can switch the lever position by operating the wiper lever 90 to a desired lever position among the four lever positions. The wiper lever 90 maintains the current lever position unless an operation of switching the lever position is performed. Further, hereinafter, the lever position of the wiper lever 90 is also simply referred to as “lever position”.

### Terminal Device

The terminal device 3 is a computer including a control unit 3a, a communication unit 3b, and a touch panel 3c. The terminal device 3 is implemented by, for example, a portable computer such as a smartphone in which a predetermined program including remote parking application software (hereinafter, also referred to as “remote parking application”) to be described later is installed.

The control unit 3a is implemented by, for example, a processor that performs various calculations, and controls the entire terminal device 3 according to a program or the like installed in the terminal device 3. The communication unit 3b is a communication interface that performs wireless communication with the vehicle 2 under the control of the control unit 3a. That is, the terminal device 3 (for example, the control unit 3a) may communicate with the vehicle 2 (for example, the control device 30) via the communication unit 3b.

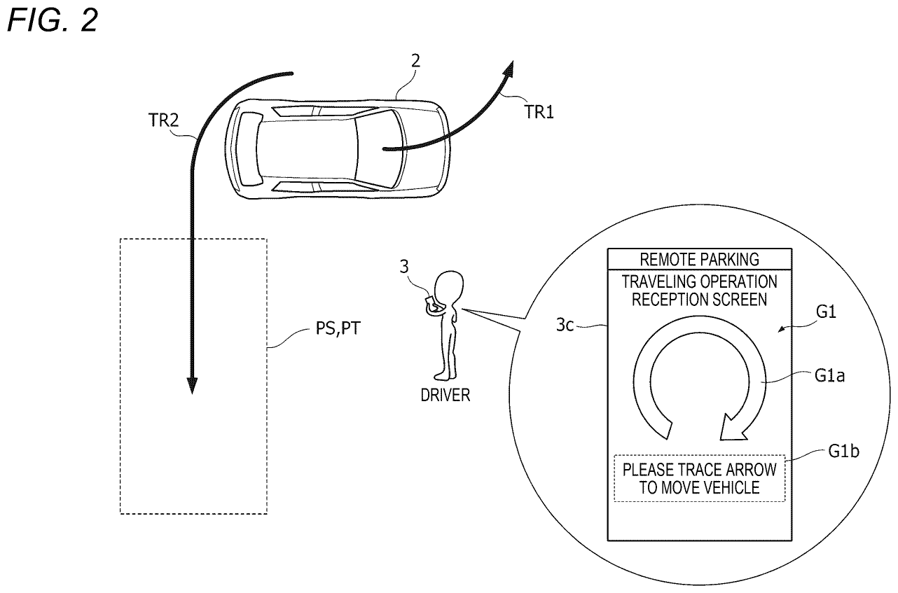

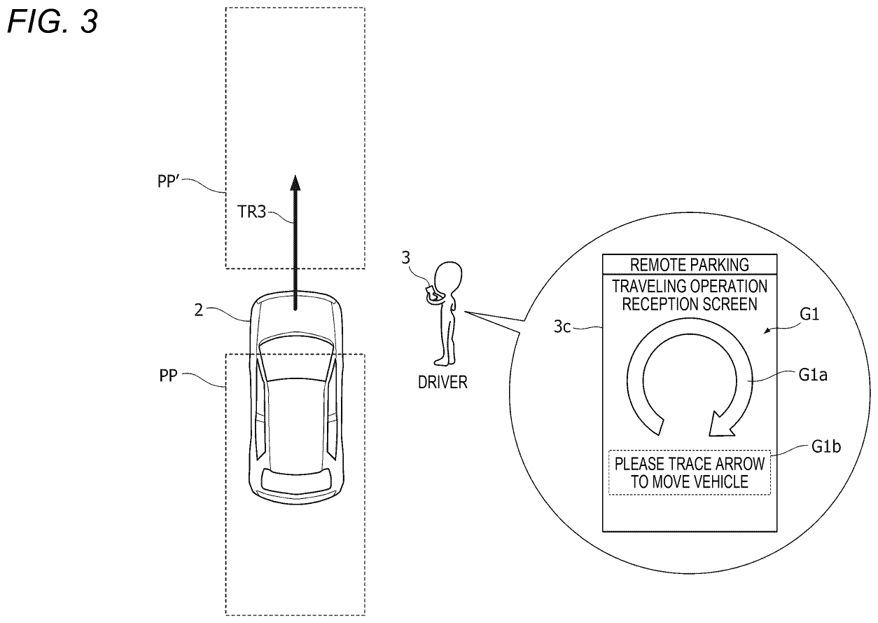

The touch panel 3c functions as an input device that receives input of various types of information to the terminal device 3 and as a display device controlled by the control unit 3a. For example, the touch panel 22 displays a display screen (for example, a traveling operation reception screen G1 shown in FIGS. 2 and 3) for receiving an operation related to the remote parking or the remote exiting, and receives an operation related to the remote parking or the remote exiting via the display screen.

### 2. Remote Parking and Remote Exiting

Next, the remote parking and the remote exiting will be described.

### Remote Parking

FIG. 2 is a diagram showing an example of the remote parking. For example, when an operation of executing the remote parking is detected by the operation detection unit 125, the control device 30 detects the parking available position PS, where the vehicle 2 can be parked, based on the detection result of the external environment sensor 11. At this time, the control device 30 may detect areas at each of which no other vehicle is parked among areas partitioned by white lines or the like as the parking available positions PS, or may detect any area at which the vehicle 2 can be physically parked as the parking available position PS.

Next, the control device 30 sets the target parking position PT based on the detected parking available position PS. As an example, the control device 30 sets, as the target parking position PT, the parking available position PS designated as the target parking position PT by the driver among the detected parking available positions PS. From a viewpoint of improving convenience of the driver, it is preferable that the driver can designate not only the target parking position PT but also a parking method (for example, whether to perform forward parking or reverse parking) to the target parking position PT.

Next, the control device 30 creates an action plan for moving the vehicle 2 from the current position of the vehicle 2 to the target parking position PT. The action plan generated in this case includes a travel trajectory for moving the vehicle 2 from the current position to the target parking position PT. In this case, the control device 30 preferably generates the action plan in consideration of the parking method designated by the driver. In an example shown in FIG. 2, an action plan is created in which the vehicle 2 is temporarily moved forward along a travel trajectory TR1 and then moved backward to the target parking position PT along a travel trajectory TR2.

Next, the control device 30 causes the touch panel 22 to display, for example, a message such as “the remote parking is possible using a smartphone when you set the shift position to P and get off”. Accordingly, a procedure for performing the remote parking can be guided to the driver. Then, after setting the shift position of the vehicle 2 to “P (parking)”, the driver starts the remote parking application on the terminal device 3 and gets off the vehicle 2.

The terminal device 3 in which the remote parking application is started displays the traveling operation reception screen G1 on the touch panel 3c. As shown in FIG. 2, on the traveling operation reception screen G1, for example, an arc-shaped arrow image G1a is displayed at a center of the screen, and traveling operation guidance information G1b for guiding an operation (hereinafter, also referred to as “traveling operation”) for causing the vehicle 2 to travel (that is, move) is displayed below the arrow image G1a.

The arrow image G1a indicates a position and a direction that the driver is to trace with a fingertip. In the present embodiment, an operation of tracing the position indicated by the arrow image G1a (in other words, a portion where the arrow image G1a is displayed) with the fingertip in the direction indicated by the arrow image G1a is the traveling operation.

Therefore, as the traveling operation guidance information G1b, a message such as “please trace the arrow to move the vehicle” is displayed. By displaying such a traveling operation reception screen G1 on the terminal device 3, the driver can be guided with intuitive and easy-to-understand guidance on traveling operations.

When an operation of tracing the position indicated by the arrow image G1a in the direction indicated by the arrow image G1a is performed on the traveling operation reception screen G1, the terminal device 3 receives the operation as the traveling operation. When receiving the traveling operation, the terminal device 3 transmits information indicating that the traveling operation has been performed to the control device 30 via the communication unit 3b.

When receiving the information indicating that the traveling operation has been performed, the control device 30 moves the vehicle 2 according to the action plan. At this time, the control device 30 automatically operates the steering wheel 46 or the like such that the vehicle 2 moves along the travel trajectory contained in the action plan. Accordingly, the vehicle 2 may move to the target parking position PT by automatic steering through a remote operation using the terminal device 3. Then, when the vehicle 2 reaches the target parking position PT, the control device 30 stops the vehicle 2, locks a door of the vehicle 2, and turns off an ignition power supply.

### Remote Exiting

FIG. 3 is a diagram showing an example of the remote exiting. For example, when the ignition power supply is turned off and the vehicle 2 is parked, the control device 30 turns on the ignition power supply and activates the vehicle 2 when receiving, from the outside (for example, the terminal device 3), information indicating that the remote exiting is to be performed.

Next, the control device 30 creates an action plan for moving the vehicle 2 from a parking position PP where the vehicle 2 is parked to a predetermined exiting position PP′. The action plan generated in this case includes a travel trajectory for moving the vehicle 2 from the parking position PP to the exiting position PP′. In an example shown in FIG. 3, an action plan for moving the vehicle 2 forward to the exiting position PP′ along a travel trajectory TR3 is created.

The exiting position PP′ is set based on, for example, the parking method to the parking position PP (for example, whether to perform forward parking or reverse parking), the detection result of the external environment sensor 11, and the like. Further, the control device 30 may select candidate positions that may become the exiting position PP′ based on the detection result of the external environment sensor 11 or the like, and may set a candidate position designated by the driver among these candidate positions as the exiting position PP′. As another example, the control device 30 may cause the driver to designate an exiting method from the parking position PP (for example, whether to perform forward exiting or reverse exiting), and set a candidate position corresponding to the exiting method as the exiting position PP′.

When the action plan is created, the control device 30 notifies the driver via the terminal device 3 that preparation for the remote exiting is possible, and unlocks the door of the vehicle 2. Then, the driver starts the remote parking application on the terminal device 3.

The terminal device 3 in which the remote parking application is started displays the traveling operation reception screen G1 on the touch panel 3c. Then, when an operation of tracing the position indicated by the arrow image G1a in the direction indicated by the arrow image G1a is performed on the traveling operation reception screen G1, the terminal device 3 receives the operation as the traveling operation. When receiving the traveling operation, the terminal device 3 transmits the information indicating that the traveling operation has been performed to the control device 30 via the communication unit 3b.

When receiving the information indicating that the traveling operation has been performed, the control device 30 moves the vehicle 2 according to the action plan. At this time, the control device 30 automatically operates the steering wheel 46 or the like such that the vehicle 2 moves along the travel trajectory contained in the action plan. Accordingly, the vehicle 2 may move to exiting position PP′ by automatic steering through a remote operation using the terminal device 3. When the vehicle 2 reaches the exiting position PP′, the control device 30 stops the vehicle 2. Accordingly, the driver can get on the vehicle 2 at the exiting position PP′.

When getting on the vehicle 2 at the exiting position PP′, the driver performs a predetermined operation inside the vehicle 2 to notify the control device 30 that the driver has got on the vehicle 2. For example, the driver operates a predetermined operator (for example, the SSSW, the brake pedal 62, or the steering wheel 46) provided in the vehicle 2 to notify the control device 30 that the driver has got on the vehicle 2. In response to the notification, the control device 30 sets the vehicle 2 to a state where normal driving is possible. Here, the normal driving is, for example, driving using operators provided in the vehicle 2, such as the steering wheel 46, the accelerator pedal 52, and the brake pedal 62.

### 3. Wiper Control

Next, control on the wiper 80 performed by the control device 30 will be described.

### Wiper Control in Normal Times

For example, the control device 30 controls the wiper 80 based on the lever position of the wiper lever 90 in normal times in which the ignition power supply is turned on (that is, the vehicle 2 is being activated) and the remote parking or the remote exiting is not being performed. Accordingly, the wiper 80 can operate in a manner desired by the driver in normal times.

More specifically, when the lever position is “OFF” in normal times, the control device 30 does not let the wiper 80 to operate. When the lever position is “LO” in normal times, the control device 30 lets the wiper 80 to operate in a low-speed operation mode in which wiping is performed a first number of times (for example, 45 times) per minute. When the lever position is “HI” in normal times, the control device 30 lets the wiper 80 to operate in a high-speed operation mode in which the wiping is performed a second number of times (for example, 70 times) greater than the first number of times per minute.

Further, when the lever position is “AUTO” in normal times, the control device 30 may set an operation mode of the wiper 80 to an automatic mode and let the wiper 80 to operate based on the detection result of the raindrop sensor 114. In this case, for example, when “no raindrop” is detected by the raindrop sensor 114, the control device 30 does not operate the wiper 80. On the other hand, when “the amount of raindrops: small” is detected by the raindrop sensor 114, the control device 30 intermittently lets the wiper 80 to operate.

During the intermittent operation, the wiper 80 operates at a lower frequency than in the low-speed operation mode. Further, when “the amount of raindrops: middle” is detected by the raindrop sensor 114, the control device 30 lets the wiper 80 to operate in the low-speed operation mode. Then, when “the amount of raindrops: large” is detected by the raindrop sensor 114, the control device 30 lets the wiper 80 to operate in the high-speed operation mode.

Wiper Control during Remote Parking and Remote Exiting

Regarding the remote parking, the driver is in the vehicle 2 until immediately before the remote parking. Therefore, there is a high possibility that the lever position during the remote parking is at an appropriate position in consideration of a situation of the vehicle 2 at that time. On the other hand, the remote exiting may be performed before the driver gets on the vehicle 2. Therefore, it is sufficiently considered that the lever position during the remote exiting is not at an appropriate position.

For example, in a case where the remote exiting is performed after snowfall, it is assumed that the wiper 80 remains upright during the remote exiting. Further, while the vehicle 2 is being parked, there is a possibility that foreign matter such as dust adheres to the front windshield, or the wiper 80 is fixed to the front windshield due to snow, ice, or the like. In such a situation, when the wiper 80 operates, the wiper 80 (for example, a wiper blade) may be deteriorated or damaged, or the front windshield may be damaged.

Therefore, the control device 30 enables the operation of the wiper 80 during the remote parking, and restricts the operation of the wiper 80 during the remote exiting.

For example, during the remote parking, the control device 30 controls the wiper 80 based on the lever position in the same manner as in normal times. On the other hand, during the remote exiting, the control device 30 prohibits wiping of the wiper 80 and does not operate the wiper 80 regardless of the lever position.

Since the driver gets off the vehicle 2 during the remote parking, the lever position during the remote parking can be said to be the lever position set by the driver before the parking is started. Therefore, during the remote parking, the control device 30 may let the wiper 80 to operate based on the setting made before the parking is started. On the other hand, during the remote exiting, the control device 30 does not operate the wiper 80 regardless of the setting made before the exiting is started.

In this way, by enabling the operation of the wiper 80 during the remote parking and restricting the operation of the wiper 80 during the remote exiting, it is possible to prevent breaking down or damage of the wiper 80 or the front windshield due to the wiper 80 operating during the remote exiting. Further, during the remote parking in which the wiper 80 or the front windshield is unlikely to break down or be damaged even when the wiper 80 operates, the front windshield can be wiped (that is, cleaned) by the wiper 80.

In particular, in order to the time and efforts required to switch the lever position, the driver often sets the lever position to “AUTO” at all times and sets the operation mode of the wiper 80 to the automatic mode. In this regard, according to the control device 30, even when the operation mode of the wiper 80 is set to the automatic mode, the wiper 80 can be prevented from operating regardless of the detection result of the raindrop sensor 114 during the remote exiting. Therefore, it is possible to prevent the breaking down or the damage of the wiper 80 or the front windshield due to the wiper 80 operating during the remote exiting.

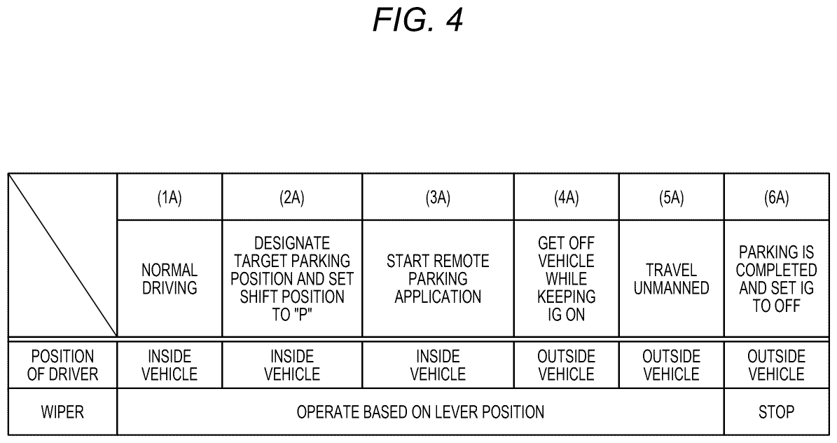

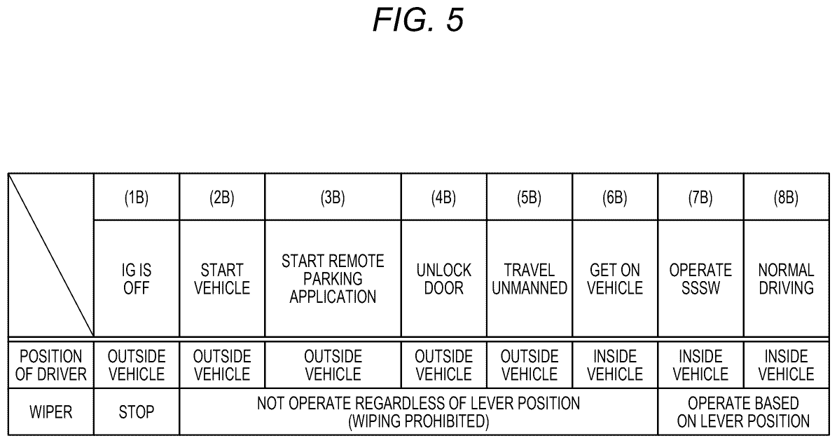

Hereinafter, a specific example of the control on the wiper 80 performed by the control device 30 during the remote parking and the remote exiting will be described with reference to FIGS. 4 and 5.

Example of Wiper Control during Remote Parking

FIG. 4 is a diagram showing an example of the control on the wiper 80 during the remote parking. As shown in FIG. 4, when the remote parking is performed, the driver designates the target parking position PT and sets the shift position of the vehicle 2 to “P” (see “2A” in FIG. 4) after normally driving the vehicle 2 (see “1A” in FIG. 4). Then, the driver starts the remote parking application on the terminal device 3 (see “3A” in FIG. 4). Thereafter, the driver gets off the vehicle 2 while keeping the ignition power supply on (see “4A” in FIG. 4).

When the driver who gets off the vehicle 2 performs the traveling operation on the terminal device 3, the vehicle 2 travels unattended (see “5A” in FIG. 4). In other words, the vehicle 2 moves by automatic steering. Then, in response to completion of the parking of the vehicle 2 to the target parking position PT, the control device 30 turns off the ignition power supply of the vehicle 2 (see “6A”in FIG. 4).

The control device 30 may let the wiper 80 to operate based on the lever position in periods from (1A) to (5A) during a series of periods from (1A) to (6A) shown in FIG. 4. Accordingly, during the remote parking in which the wiper 80 or the front windshield is unlikely to break down or be damaged even when the wiper 80 operates, the front windshield can be wiped by the wiper 80. As indicated by (6A) in FIG. 4, when the ignition power supply is turned off, the wiper 80 stops.

Example of Wiper Control during Remote Exiting

FIG. 5 is a diagram showing an example of the control on the wiper 80 during the remote exiting. As shown in FIG. 5, when the remote exiting is performed, the driver starts the vehicle 2 whose ignition power supply is turned off from the outside of the vehicle using the terminal device 3 (see “1B” and “2B” in FIG. 5). Then, the driver starts the remote parking application on the terminal device 3 (see “3B” in FIG. 5). Further, the control device 30 unlocks the door of the vehicle 2 (see “4B”in FIG. 5).

Thereafter, when the driver outside the vehicle performs the traveling operation on the terminal device 3, the vehicle 2 travels unattended (see “5B” in FIG. 5). Then, when the vehicle 2 reaches the exiting position PP′, the control device 30 stops the vehicle 2. Accordingly, the driver can get on the vehicle 2 at the exiting position PP′.

Then, the driver gets on the vehicle 2 at the exiting position PP′ (see “6B” in FIG. 5), and notifies the control device 30 that the driver has got on the vehicle 2 by operating, for example, the SSSW (see “7B” in FIG. 5). In response to the notification, the control device 30 sets the vehicle 2 into a state where normal driving is possible (see “8B”in FIG. 5).

The control device 30 prohibits the wiping of the wiper 80 in periods from (2B) to (6B) during a series of periods from (1B) to (8B) shown in FIG. 5 and does not operate the wiper 80 regardless of the lever position. Accordingly, it is possible to prevent the breaking down or the damage of the wiper 80 or the front windshield due to the wiper 80 operating during the remote exiting.

Then, as shown in (6B) in FIG. 5, when the operation of the wiper 80 is restricted, the control device 30 releases the operation restriction of the wiper 80 based on that a predetermined operation (an operation on the SSSW in the example shown in FIG. 5) has been performed inside the vehicle 2. Accordingly, when the driver gets on the vehicle 2 and performs normal driving after the remote exiting, the wiper 80 operate in a manner desired by the driver.

In the vehicle 2, for example, since the front camera 111a is provided on the front grille of the vehicle 2, it should be noted that the acquisition of the peripheral information of the vehicle 2 is not hindered even if the wiper 80 does not operate during the remote exiting.

### Modification

Next, modifications of the above embodiment will be described.

### First Modification

Next, a first modification will be described. The present modification is an example in which the control device 30 controls the wiper 80 differently in normal times and during the remote parking.

During the remote parking, the driver may operate the terminal device 3 in the periphery of the vehicle 2 (in other words, at a location relatively close to the vehicle 2). Therefore, when the wiper 80 operates during the remote parking in the same manner as in normal times, water or the like scattered due to the operation of the wiper 80 may splash on the driver.

Therefore, in the present modification, the control device 30 reduces a speed of the wiper 80 at the time of moving and/or reduces the number of times the wiper 80 moves per unit time during the remote parking as compared with in normal times.

For example, it is assumed that the lever position is “LO”, that is, the mode is the low-speed operation mode. In this case, in normal times, the control device 30 causes the wiper 80 to perform wiping the first number of times (for example, 45 times) per minute. On the other hand, during the remote parking, the control device 30 causes the wiper 80 to perform wiping a third number of times (for example, 15 times) smaller than the first number of times per minute.

For example, it is assumed that the lever position is “HI”, that is, the mode is the high-speed operation mode. In this case, in normal times, the control device 30 causes the wiper 80 to perform wiping the second number of times (for example, 70 times) per minute. On the other hand, during the remote parking, the control device 30 causes the wiper 80 to perform wiping a fourth number of times (for example, 25 times) smaller than the second number of times per minute. The third number of times and the fourth number of times may be different from each other (for example, the fourth number of times>the third number of times), or may be the same.

In the example described here, the number of times the wiper 80 moves per unit time is reduced during the remote parking as compared with in normal times, but the present disclosure is not limited thereto. In addition to or instead of this, during the remote parking, the speed when the wiper 80 moves (that is, during wiping) may be slower than in normal times. As an example, during the remote parking, the control device 30 may slowly move the wiper 80 by taking a time of about three times that in normal times for one wiping.

In this way, during the remote parking, by reducing the speed of the wiper 80 at the time of moving and/or reducing the number of times the wiper 80 moves per unit time as compared with in normal times, it is possible to prevent water or the like scattered by operating the wiper 80 during the remote parking from splashing on the driver who operates the terminal device 3 (that is, performs the remote operation) in the periphery of the vehicle 2.

Further, during the remote parking, the control device 30 may reduce the speed of the wiper 80 at the time of moving and/or reduce the number of times the wiper 80 moves per unit time, based on a distance between the driver who performs the remote operation and the vehicle 2.

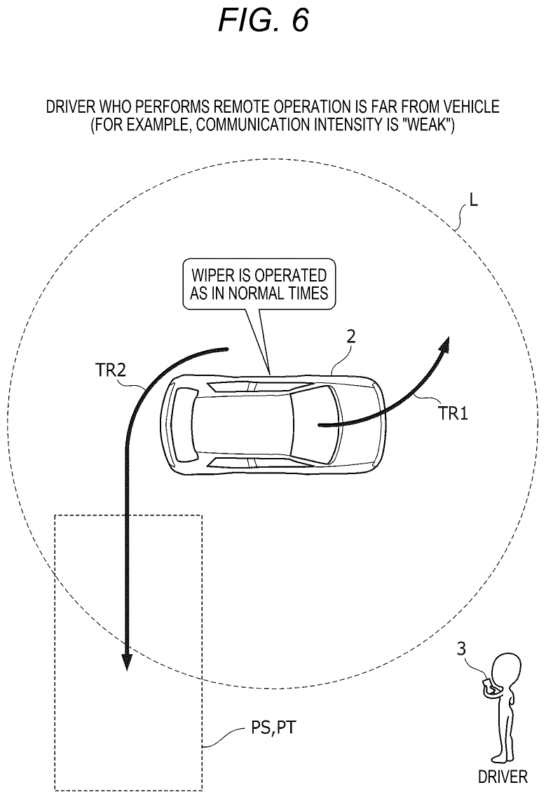

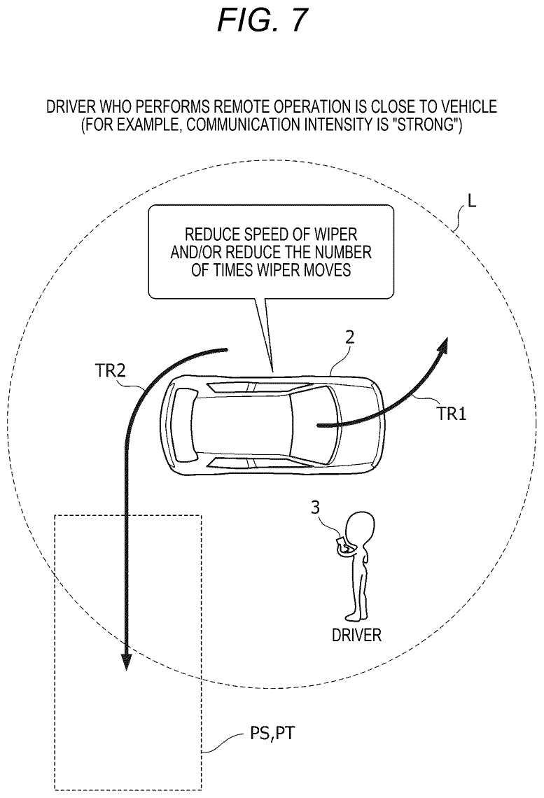

FIG. 6 is a diagram showing an example of a case where the driver who performs the remote operation is far from the vehicle 2 in the first modification. FIG. 7 is a diagram showing an example of a case where the driver who performs the remote operation is close to the vehicle 2 in the first modification.

For example, as shown in FIG. 6, when the distance between the driver who performs the remote operation using the terminal device 3 and the vehicle 2 is equal to or greater than a predetermined distance L (that is, when the driver who performs the remote operation is far from the vehicle 2), the control device 30 may let the wiper 80 to operate in the same manner as in normal times. This is because, when the driver who performs the remote operation is far from the vehicle 2, even if the wiper 80 operates in the same manner as in normal times, it is considered that water or the like scattered due to the operation of the wiper 80 is unlikely to splash on the driver.

On the other hand, as shown in FIG. 7, when the distance between the driver who performs the remote operation using the terminal device 3 and the vehicle 2 is less than the predetermined distance L (that is, when the driver who performs the remote operation is close to the vehicle 2), the control device 30 may reduce the speed of the wiper 80 at the time of moving and/or reduce the number of times the wiper 80 moves per unit time as compared with in normal times. Accordingly, it is possible to prevent water or the like scattered by letting the wiper 80 to operate during the remote parking from splashing on the driver who operates the terminal device 3 (that is, performs the remote operation) in the periphery of the vehicle 2.

The distance between the driver and the vehicle 2 can be specified based on, for example, radio wave intensity (in other words, communication intensity) related to the communication (for example, Bluetooth) between the terminal device 3 and the vehicle 2 or information acquired by the external environment sensor 11 (for example, the camera 111).

In this way, during the remote parking, by reducing the speed of the wiper 80 at the time of moving and/or reducing the number of times the wiper 80 moves per unit time based on the distance between the driver who performs the remote operation and the vehicle 2, the wiper 80 can operate appropriately depending on the distance between the driver who performs the remote operation and the vehicle 2.

### Second Modification

Next, a second modification will be described. The present modification is an example in which the control device 30 may restrict the operation of the wiper 80 even during the remote parking. For example, a case is also assumed in which the remote exiting of the vehicle 2 is performed to take out a package from the parked vehicle 2, and the remote parking of the vehicle 2 is performed immediately after the package is taken out. In such a case, when the wiper 80 operates during the remote parking immediately after the remote exiting even though the wiper 80 does not operate during the remote exiting, a sense of discomfort may be given to the driver.

Therefore, in the present modification, the control device 30 lets the wiper 80 to operate based on an operation time of the wiper 80 or the presence or absence of the operation of the wiper 80 before the remote parking is started.

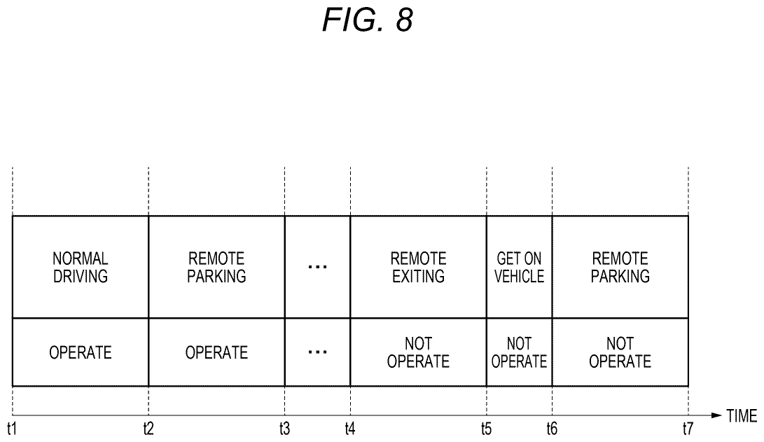

FIG. 8 is a diagram showing an example of the control on the wiper 80 in the second modification. In the example shown in FIG. 8, it is assumed that the wiper 80 operates for a predetermined time or more (for example, one minute or more) during the normal driving from a time t1 to a time t2. In this case, the control device 30 lets the wiper 80 to operate also during the remote parking from the time t2 to a time t3 immediately thereafter.

Further, the control device 30 restricts the operation of the wiper 80 and does not operate the wiper 80 during the remote exiting from a time t4 to a time t5. Then, it is assumed that an operation of letting the wiper 80 to operate is not performed in a period from the time t5 to a time t6 (a period in which the driver or the like is getting on the vehicle 2) immediately thereafter. In this case, the control device 30 continues the operation restriction on the wiper 80 and does not operate the wiper 80 even during the remote parking from the time t6 to a time t7 immediately thereafter.

In this way, during the remote parking, the control device 30 may let the wiper 80 to operate based on the operation time of the wiper 80 or the presence or absence of the operation of the wiper 80 before the parking is started. In other words, when the operation time of the wiper 80 in a certain period (for example, 10 minutes) before the remote parking is started is less than a predetermined time or the wiper 80 does not operate in the certain period, the control device 30 may restrict the operation of the wiper 80 during the remote parking. In this way, it is possible to prevent the wiper 80 from operating in a situation where the operation of the wiper 80 during the remote parking may give a sense of discomfort to the driver.

As described above, according to the control device 30 and the vehicle 2 of the present embodiment, it is possible to appropriately control the wiper 80 which is an example of a cleaning device, and to prevent the breaking down or the damage of the wiper 80 or the front windshield during the parking and the exiting of the vehicle 2 performed by the remote operation.

Although an embodiment of the present disclosure has been described above, it goes without saying that the present disclosure is not limited to the embodiment. It is apparent that those skilled in the art can conceive of various modifications and changes within the scope described in the claims, and it is understood that such modifications and changes naturally fall within the technical scope of the present disclosure. Further, the constituent elements in the above embodiment may be freely combined without departing from the gist of the disclosure.

For example, in the above embodiment, the wiper 80 that cleans (in other words, wipes) the front windshield is exemplified as the cleaning device, but the present disclosure is not limited thereto. For example, the cleaning device may be a wiper provided at each of a front and a rear of the vehicle 2. That is, the cleaning device may include a rear wiper that wipes a rear windshield in addition to the wiper 80 as a front wiper that wipes the front windshield. The control device 30 may restrict the operation of each of the front and rear wipers during the remote exiting. In this way, by restricting the operation of each of the front and rear wipers during the remote exiting, it is possible to prevent the breaking down or the damage of the front wiper or the rear wiper, or the front windshield or the rear windshield due to the front and rear wipers operating during the remote exiting.

The cleaning device is not limited to the wiper, and may be, for example, a headlight washer that cleans a headlight (not shown) of the vehicle 2, a rear camera washer that cleans a lens portion of the rear camera 111b, or the like.

In the present description, at least the following matters are described. In the parentheses, the corresponding constituent elements and the like in the above embodiment are shown, but the present disclosure is not limited thereto.
(1) A vehicle control device (control device 30) that controls a vehicle (vehicle 2) configured to perform parking and exiting by a remote operation, in which
the vehicle includes a cleaning device (wiper 80) configured to clean a predetermined portion of an exterior of the vehicle, and
the vehicle control device enables an operation of the cleaning device during the parking performed by the remote operation and restricts the operation of the cleaning device during the exiting performed by the remote operation According to the above (1), it is possible to appropriately control the cleaning device during the parking and the exiting of the vehicle performed by the remote operation and prevent breaking down or damage of the cleaning device itself or the exterior of the vehicle.
(2) The vehicle control device according to the above (1), in which
during the parking performed by the remote operation, the vehicle control device lets the cleaning device to operate based on a setting made before the parking is started.

According to the above (2), during the parking of the vehicle performed by the remote operation, the cleaning device can be operated in a manner desired by a driver.
(3) The vehicle control device according to the above (1), in which
a mode related to the operation of the cleaning device includes an automatic mode in which the cleaning device operates based on a detection result of a sensor (raindrop sensor 114) provided in the vehicle, and
the vehicle control device does not let the cleaning device to operate regardless of the detection result during the exiting performed by the remote operation when the mode related to the operation of the cleaning device is set to the automatic mode.

According to the above (3), even when the automatic mode is set, it is possible to prevent the breaking down or the damage of the cleaning device itself or the exterior of the vehicle due to the cleaning device operating during the exiting performed by the remote operation.
(4) The vehicle control device according to any one of the above (1) to (3), in which
the vehicle control device stops restricting the operation of the cleaning device when a predetermined operation is performed inside the vehicle.

According to the above (4), when the driver gets on the vehicle and performs driving after the exiting performed by the remote operation, the cleaning device operate in a manner desired by the driver.
(5) The vehicle control device according to any one of the above (1) to (3), in which
the cleaning device is a wiper (wiper 80), and
during the parking performed by the remote operation, the vehicle control device reduces a speed of the wiper at a time of moving and/or reduces a number of times the wiper moves per unit time as compared with in normal times.

According to the above (5), it is possible to prevent water or the like scattered by letting the cleaning device to operate during the parking performed by the remote operation from splashing on the driver who performs the remote operation in the periphery of the vehicle.
(6) The vehicle control device according to the above (5), in which
during the parking performed by the remote operation, the vehicle control device reduces the speed and/or the number of times based on a distance between a driver who performs the remote operation and the vehicle.

According to the above (6), the cleaning device can appropriately operate according to the distance between the driver who performs the remote operation and the vehicle.
(7) The vehicle control device according to any one of the above (1) to (3), in which
during the parking performed by the remote operation, the vehicle control device lets the cleaning device to operate based on an operation time of the cleaning device before the parking is started or whether the cleaning device operates or not before the parking is started.

According to the above (7), it is possible to prevent the cleaning device from operating in a situation where the operation of the cleaning device during the parking performed by the remote operation may give a sense of discomfort to the driver.
(8) The vehicle control device according to any one of the above (1) to (3), in which
the cleaning device is a wiper provided at each of a front and a rear of the vehicle, and
the vehicle control device restricts an operation of each of the front and rear wipers during the exiting performed by the remote operation.

According to the above (8), it is possible to prevent breaking down or damage of the front and rear wipers or the exterior of the vehicle due to the front and rear wipers operating during the exiting performed by the remote operation.
(9) A vehicle configured to perform parking and exiting by a remote operation, the vehicle including:
a cleaning device configured to clean a predetermined portion of an exterior of the vehicle; and
a vehicle control device configured to control the vehicle, in which
the vehicle control device enables an operation of the cleaning device during the parking performed by the remote operation and restricts the operation of the cleaning device during the exiting performed by the remote operation.

According to (9), it is possible to appropriately control the cleaning device during the parking and the exiting of the vehicle performed by the remote operation and prevent the breaking down or the damage of the cleaning device or the exterior of the vehicle.

1. A vehicle control device that controls a vehicle configured to perform parking and exiting by a remote operation, wherein
the vehicle includes a cleaning device configured to clean a predetermined portion of an exterior of the vehicle, and
the vehicle control device enables an operation of the cleaning device during the parking performed by the remote operation and restricts the operation of the cleaning device during the exiting performed by the remote operation.

2. The vehicle control device according to claim 1, wherein
during the parking performed by the remote operation, the vehicle control device lets the cleaning device to operate based on a setting made before the parking is started.

3. The vehicle control device according to claim 1, wherein
a mode related to the operation of the cleaning device includes an automatic mode in which the cleaning device operates based on a detection result of a sensor provided in the vehicle, and
the vehicle control device does not let the cleaning device to operate regardless of the detection result during the exiting performed by the remote operation when the mode related to the operation of the cleaning device is set to the automatic mode.

4. The vehicle control device according to claim 1, wherein
the vehicle control device stops restricting the operation of the cleaning device when a predetermined operation is performed inside the vehicle.

5. The vehicle control device according to claim 1, wherein
the cleaning device is a wiper, and
during the parking performed by the remote operation, the vehicle control device reduces a speed of the wiper at a time of moving and/or reduces a number of times the wiper moves per unit time as compared with in normal times.

6. The vehicle control device according to claim 5, wherein
during the parking performed by the remote operation, the vehicle control device reduces the speed and/or the number of times based on a distance between a driver who performs the remote operation and the vehicle.

7. The vehicle control device according to claim 1, wherein
during the parking performed by the remote operation, the vehicle control device lets the cleaning device to operate based on an operation time of the cleaning device before the parking is started or whether the cleaning device operates or not before the parking is started.

8. The vehicle control device according to claim 1, wherein
the cleaning device is a wiper provided at each of a front and a rear of the vehicle, and
the vehicle control device restricts an operation of each of the front and rear wipers during the exiting performed by the remote operation.

9. A vehicle configured to perform parking and exiting by a remote operation, the vehicle comprising:
a cleaning device configured to clean a predetermined portion of an exterior of the vehicle; and
a vehicle control device configured to control the vehicle, wherein
the vehicle control device enables an operation of the cleaning device during the parking performed by the remote operation and restricts the operation of the cleaning device during the exiting performed by the remote operation.
